(19) United States
(12) Patent Application Publication
(10) Pub. No.: US 2026/0069508 A1
(43) Pub. Date: Mar. 12, 2026

(54) HOLDING STRAP FOR A BABY BOTTLE

(71) Applicants: Breannan Marrder, Sandy, UT (US); Obed Marrder, Sandy, UT (US)

(72) Inventors: Breannan Marrder, Sandy, UT (US); Obed Marrder, Sandy, UT (US)

(21) Appl. No.: 18/827,674

(22) Filed: Sep. 7, 2024

(51) Int. Cl. A61J 9/06

(52) U.S. Cl. CPC A61J 9/0623

(57) ABSTRACT

A holding strap operable to hold a baby bottle in place while a baby or infant is nursing, the holding strap having two circular end portions, one affixed to cylindrical receptacle operable to hold a baby bottle. An elongated strap interconnects the circular end portions.

### BACKGROUND OF THE INVENTION

### Field of the Invention

This invention relates to drinking implements, and more particularly relates to a holder for baby bottle.

### Description of the Related Art

Baby bottles have been well-known in the art for decades. Baby bottles are used for the artificial nursing of infant children in various forms, shapes, and configurations. The process of trying to transition babies from nursing to bottles can become tiresome for parents, often requiring a parent to spend long lengths of time with a baby cradled in one arm while holding a bottle in the other hand. Traditional baby bottles have to be lifted to an excessive height for a baby to drink from them, and as such often require exertion of effort.

Mothers are able to nurse while holding a baby with both arms, but when feeding a baby with a bottle, the second arm is required to hold the bottle. Various methods have been employed by parents to try and find more convenient ways to bottle feed including tucking a bottle in a pillow, propping the bottle up with a blanket or tucking it under arms to hold the bottle for the baby, none of which are efficient.

The cradle position from which babies typically feed while resting on their backs differs from the position used by babies when breastfeeding. In the cradle position, the baby is out of forward contact with a mother and not utilizing innate feeding reflexes. The front area of a baby is meant to engage the forward belly of the baby's mother. The cradle position is necessary, however, when making use of traditional bottles which rely on gravity to move fluid to the nozzle and dispense it. The nondevelopment of these reflexes and can limit success in getting a baby to transition and adopt the use of a traditional bottle.

It is an object of the present invention to provide a baby bottle holder which overcomes these difficulties. These and other objects and advantages of the present invention are desirable in the art.

### SUMMARY OF THE INVENTION

From the foregoing discussion, it should be apparent that a need exists for a holding strap for a baby bottle. Beneficially, such an apparatus would overcome many of the difficulties and safety concerns expressed. The present invention has been developed in response to the problems and needs in the art that have not yet been fully solved by currently available apparati and methods. Accordingly, the present invention has been developed to provide a holding strap for a baby bottle, the holding strap comprising: an elongated strap; a circular proximal end portion affixed to the elongated strap; a circular distal end portion affixed to the elongated strap; and a cylindrical receptacle affixed to one of the proximal end and the distal end operable to receive and hold a baby bottle. The receptacle may comprise ribbing on an interior surface

The proximal end portion, the distal end portion, and the elongated strap may be formed as a single integrated piece. In some embodiments, the proximal end portion, the distal end portion and the elongated strap are formed from a polymeric material.

The elongated strap may define an elongated recess. The receptacle may comprise a laterally-protruding tab operable to reduce a friction fit between the receptacle and a baby bottle.

The receptacle may comprise ribbing on an interior surface. The circular distal end may be counterweighted to offset a portion of the weight of a bottle resting in the proximal end such that a weight of the distal end exceeds a weight of the proximal end.

A lower surface of the proximal end may define one or more apertures operable to permit through passage of ambient air into the cylindrical receptacle, in some embodiments.

A second holding strap for a baby bottle is providing, the holding strap comprising: an elongated strap; a circular proximal end portion affixed to the elongated strap; a circular distal end portion affixed to the elongated strap; a cylindrical receptacle affixed to one of the proximal end and the distal end operable to receive and hold a baby bottle; wherein the receptacle comprises a laterally-protruding tab operable to reduce a friction fit between the receptacle and a baby bottle; and wherein the receptacle comprises ribbing on an interior surface.

The receptacle may comprise ribbing on an interior surface.

The proximal end portion, the distal end portion, and the elongated strap are formed as a single integrated piece, in some embodiments and may also be formed from polymeric material.

These features and advantages of the present invention will become more fully apparent from the following description and appended claims, or may be learned by the practice of the invention as set forth hereinafter

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric perspective view of a holding strap for an improved baby bottle in accordance with the present invention;

FIG. 2 is a lower perspective view of a holding strap for an improved baby bottle in accordance with the present invention;

FIG. 3 is a side perspective view of a holding strap for an improved baby bottle in accordance with the present invention;

FIG. 4 is a side perspective view of a holding strap for an improved baby bottle in accordance with the present invention;

FIG. 5 is a side perspective view of a holding strap for an improved baby bottle in accordance with the present invention; and

FIG. 6 is a bottom perspective view of a holding strap for an improved baby bottle in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

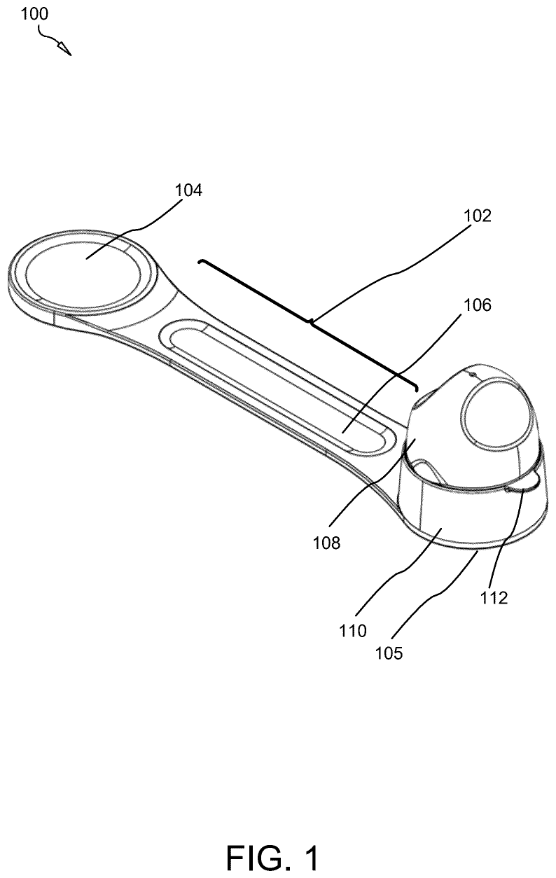

FIG. 1 is an isometric perspective view of a holding strap 100 for an improved baby bottle in accordance with the present invention.

The strap 100 comprises a distal end portion 105 and a proximal end portion 104. In various embodiments, the distal end portion 105 comprises a circular tab affixed to the strap body 102. The proximal end portion 104 also comprises a circular tab affixed to the strap body 102 at a proximal end.

The strap body 102 comprises an elongated strip or strap which interconnects the distal end portion 105 and the proximal end portion 104. The strap body 102 may comprise an elongated recessed track 106 on a top surface and/or a bottom surface.

In some embodiments, the proximal end portion 104 is heavier than the distal end portion 105 to add a counterweight to the strap 100 and offset the weight a bottle 108 which is detachably affixable to the strap 100.

In various embodiments, the strap is formed from one of polymeric materials and organic materials (such as leather).

In various embodiments, the top surface of the proximal end portion 104 is concave.

The strap 100 comprises a receptacle 110 (i.e., vessel 110) which may be cylindrical or which may define an ergonomic, concave recess (i.e., indentation). The receptacle 110 comprises a cup operable and adapted to receive a bottom portion of a baby bottle 108.

In various embodiments, the receptacle 110 comprises a tab 112 protruding laterally from a top surface of the receptacle 110 operable to release a suck fit between the receptacle 110 and the bottle 108.

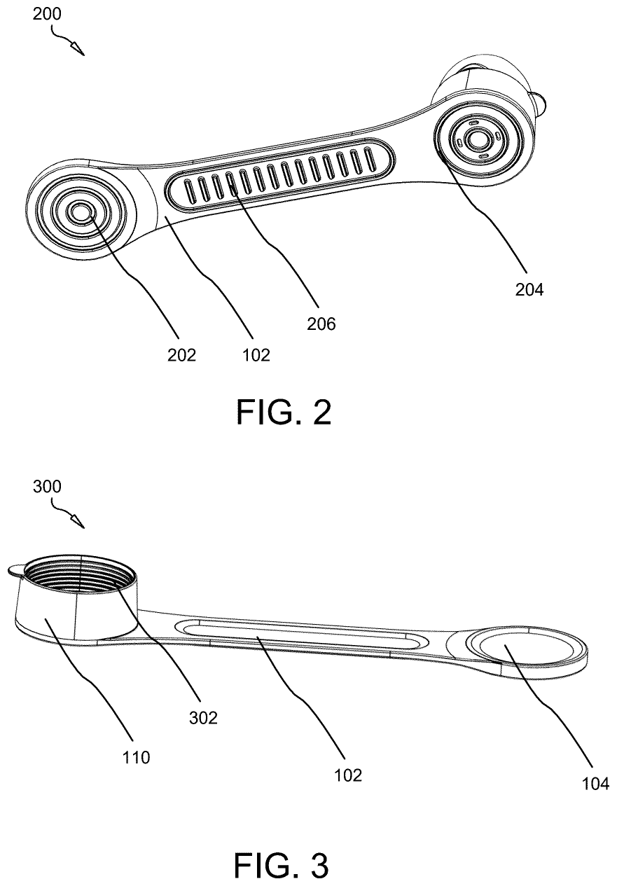

FIG. 2 is a lower perspective view of a holding strap 200 for an improved baby bottle in accordance with the present invention.

The lower side of the strap body 102 may comprise texture or ribbing 206. The lower surfaces of the proximal end portion 104 and the distal end portion 105 may each comprise concentric, circular relief texturing 202, 204 respectively.

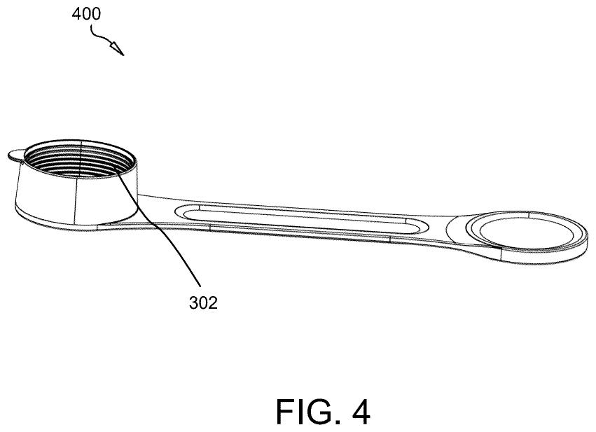

FIGS. 3-4 illustrate side perspective views of a holding strap for an improved baby bottle in accordance with the present invention.

In various embodiments, the interior surface of the receptacle 110 may be threaded or ribbed, and/or comprise ribbing 302, adapted to form a more secure friction fit with the bottle 108.

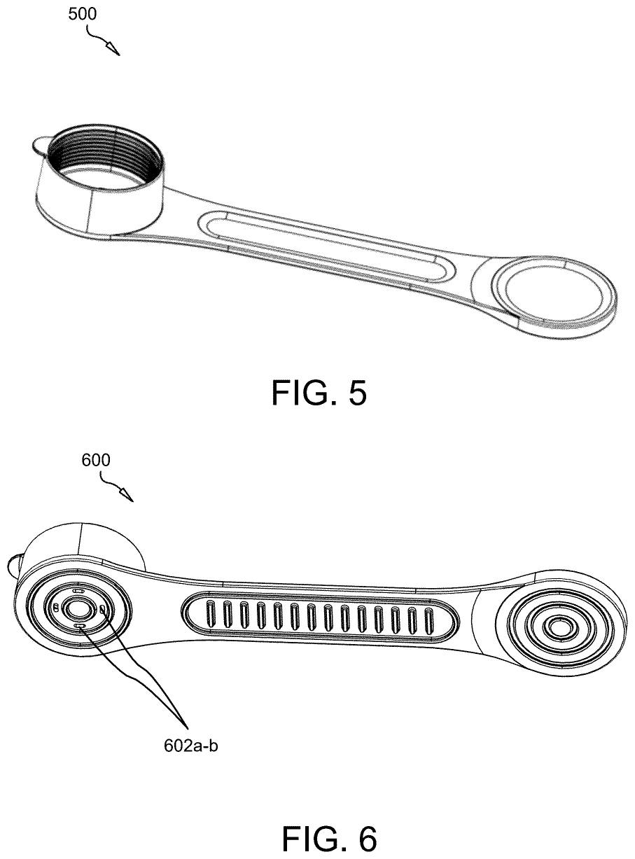

FIG. 5 is a side perspective view of a holding strap 500 for an improved baby bottle in accordance with the present invention.

As shown.

FIG. 6 is a bottom perspective view of a holding strap 600 for an improved baby bottle in accordance with the present invention.

The strap 600 may comprise ovoid apertures 602 for allowing the free flow of ambient air in and out of the receptacle 110. In this manner, a bottle 108 with a collapsible bladder may compress without negative pressure created in what would be an otherwise airtight receptacle 110. These apertures 602 may be round, ovoid, or otherwise regularly or irregularly shaped.

The present invention may be embodied in other specific forms without departing from its spirit or essential characteristics. The described embodiments are to be considered in all respects only as illustrative and not restrictive. The scope of the inventio is, therefore, indicated by the appended claims rather than by the foregoing description. All changes which come within the meaning and range of equivalency of the claims are to be embraced within their scope.

What is claimed is:

1. A holding strap for a baby bottle, the holding strap comprising:
an elongated strap;
a circular proximal end portion affixed to the elongated strap, wherein the circular proximal end portion is wider in diameter than a width of the elongated strap;
a circular distal end portion affixed to the elongated strap; and
a cylindrical receptacle affixed to one of the proximal end and the distal end operable to receive and hold a baby bottle.

2. The holding strap of claim 1, wherein the receptacle comprises ribbing on an interior surface

3. The holding strap of claim 1, wherein the proximal end portion, the distal end portion, and the elongated strap are formed as a single integrated piece.

4. The holding strap of claim 1, wherein the proximal end portion, the distal end portion and the elongated strap are formed from a polymeric material.

5. The holding strap of claim 1, wherein the elongated strap defines an elongated recess.

6. The holding strap of claim 1, wherein the receptacle comprises a laterally-protruding tab operable to reduce a friction fit between the receptacle and a baby bottle.

7. The holding strap of claim 1, wherein the receptacle comprises ribbing on an interior surface.

8. The holding strap of claim 1, wherein the circular distal end is counterweighted to offset a portion of the weight of a bottle resting in the proximal end such that a weight of the distal end exceeds a weight of the proximal end.

9. The holding strap of claim 1, wherein a lower surface of the proximal end defines one or more apertures operable to permit through passage of ambient air into the cylindrical receptacle.

10. A holding strap for a baby bottle, the holding strap comprising:
an elongated strap;
a circular proximal end portion affixed to the elongated strap;
a circular distal end portion affixed to the elongated strap;
a cylindrical receptacle affixed to one of the proximal end and the distal end operable to receive and hold a baby bottle;
wherein the receptacle comprises a laterally-protruding tab operable to reduce a friction fit between the receptacle and a baby bottle; and
wherein the receptacle comprises ribbing on an interior surface.

11. The holding strap of claim 10, wherein the receptacle comprises ribbing on an interior surface

12. The holding strap of claim 10, wherein the proximal end portion, the distal end portion, and the elongated strap are formed as a single integrated piece.

13. The holding strap of claim 10, wherein the proximal end portion, the distal end portion and the elongated strap are formed from a polymeric material.

14. The holding strap of claim 10, wherein the elongated strap defines an elongated recess.

15. The holding strap of claim 10, wherein the circular distal end is counterweighted to offset a portion of the weight of a bottle resting in the proximal end such that a weight of the distal end exceeds a weight of the proximal end.

16. The holding strap of claim 10, wherein a lower surface of the proximal end defines one or more apertures operable to permit through passage of ambient air into the cylindrical receptacle.
